(19) United States
(12) Patent Application Publication
(10) Pub. No.: US 2025/0388412 A1
(43) Pub. Date: Dec. 25, 2025

(54) APPARATUS FOR CONVEYING CONTAINERS AND ASSOCIATED OPERATING METHOD

(71) Applicant: KRONES AG, Neutraubling (DE)

(72) Inventors: Kyoung-Won LEE, Wackersdorf (DE); Michael GANDORFER, Moosburg (DE)

(21) Appl. No.: 19/247,272

(22) Filed: Jun. 24, 2025

(30) Foreign Application Priority Data
Jun. 25, 2024 (DE) 10 2024 117 932.5

(51) Int. Cl. B65G 45/22; B65G 43/00

(52) U.S. Cl. CPC B65G 45/22; B65G 43/00; B65G 2201/0235; B65G 2203/0208; B65G 2203/0266; B65G 2203/042; B65G 2203/044

(57) ABSTRACT

The invention relates, inter alia, to an apparatus for conveying containers. The apparatus has a container conveyor with a circulating conveyor element and a sensor device which is configured to detect at least one of a contamination of the circulating conveyor element, a contamination of the containers and a friction characteristic value of the circulating conveyor element. The apparatus further comprises a user interface and/or a cleaning device for cleaning the circulating conveyor element. The apparatus further comprises a processing device which is configured to operate the user interface to output a request to clean the circulating conveyor element and/or to operate the cleaning device to clean the circulating conveyor element depending on a signal output of the sensor device.

### CROSS-REFERENCE TO RELATED APPLICATIONS

This application claims the benefit under 35 U.S.C. § 119(a) of German Patent Application No. DE 10 2024 117 932.5, filed Jun. 25, 2024, entitled APPARATUS FOR CONVEYING CONTAINERS AND ASSOCIATED OPERATING METHOD, and whose entire disclosure is incorporated by reference herein.

### Technical Field

The invention relates to an apparatus for conveying containers. The invention also relates to a method for operating an apparatus for conveying containers.

### Technical Background

Containers and container packs can be transported through the individual plant parts in container processing plants and, for example, cleaned, filled, sealed, tested, labeled or printed. For example, piece goods conveyors with a circulating conveyor element can be used to transport the containers and container packs. The conveyor element serves as an endless support element that carries the containers or container packs or objects in general to be conveyed. Typically, the conveyor element can be bent upwards and downwards (and possibly also sideways) to follow the desired course of the conveyor with deflections, for example at the transition between the upper and lower strands or through curves.

In order to set a desired friction between the containers to be conveyed and the conveyor element, the conveyor elements can be lubricated. Classic belt lubrication plants with preset, cyclical metering intervals are common practice for lubricating conveyors.

WO 2015/165858 A1 relates to an apparatus for determining a frictional resistance of a transport belt surface configured for transporting containers. In order to provide an apparatus with which the frictional resistance of a transport belt surface can be determined particularly easily and accurately, a sensor unit is provided which has a sensor body arranged in a protective housing. The sensor unit is configured to be arranged in a transport stream of containers transported on the conveyor belt and to determine the frictional resistance during operation of the transport belt.

The belt lubrication plants commonly available on the market do not react to external factors that can influence the coefficient of friction. This can lead to undesirable deviations from the required friction coefficient.

The invention is based on the object of providing an improved technique for ensuring optimal operation of an apparatus for conveying containers. Preferably, the technology should particularly overcome disadvantages of known belt lubrication plants.

### SUMMARY OF THE INVENTION

The object is achieved by the features of the independent claims. Advantageous developments are specified in the dependent claims and the description.

One aspect relates to an apparatus for conveying containers for a container processing plant (e.g., beverage filling plant). The apparatus comprises a container conveyor with a circulating conveyor element (e.g., a conveyor belt, a mat chain, a hinged belt, a conveyor chain or a plate conveyor) for conveying the containers. The apparatus further comprises a sensor device which is configured to detect at least one of a contamination of the circulating conveyor element, a contamination of the containers and a friction characteristic value (e.g., friction coefficient, static friction coefficient and/or sliding friction coefficient) of the circulating conveyor element (e.g., relative to a reference body/friction body or to the containers). The apparatus further comprises at least one of a user interface and a(n) (e.g., stationary) cleaning device for cleaning the circulating conveyor element. The apparatus further comprises a processing device which is configured to operate the user interface to output a request to clean the circulating conveyor element and/or to operate the cleaning device to clean the circulating conveyor element depending on a signal output of the sensor device regarding the detected contamination (e.g., of the circulating conveyor element and/or the containers) and/or the detected friction characteristic value.

Advantageously, the apparatus enables the conveyor element to be cleaned when contamination of the conveyor element or the container is detected or when a friction characteristic value is detected that is greater than a target friction characteristic value. This can advantageously improve the operation of the container conveyor if, for example, the possibilities of a lubricating device for lubricating the circulating conveyor element have already been exhausted and have not led to the desired result (friction characteristic value). This also advantageously prevents excessive (unsuccessful) lubrication of the conveyor element, which saves lubricant and allows the container conveyor to be operated more sustainably.

In one embodiment, the sensor device has at least one (e.g., contactless or contacting) sensor for detecting the contamination of the circulating conveyor element and/or the contamination of the containers and at least one (e.g., contactless or contacting) further sensor for detecting the friction characteristic value. Alternatively, the sensor device may, for example, comprise at least one (e.g., optical) sensor which is configured to detect both the contamination of the circulating conveyor element and/or the contamination of the containers as well as the friction characteristic value.

In a further exemplary embodiment, the sensor device comprises a biofilm sensor for detecting the contamination of the circulating conveyor element and/or the contamination of the containers. This is advantageous as it allows contamination to be detected directly and particularly reliably.

In one embodiment, the sensor device can comprise a friction body and a force transducer connected thereto for detecting the friction characteristic value, wherein the friction body rests on a container contact side of the circulating conveyor element, preferably on a lower strand of the circulating conveyor element or on the upper strand of the circulating conveyor element outside a transport path for the containers (e.g., behind a transfer). Advantageously, the friction characteristic value can be reliably measured in this way without the container flow being negatively affected by the friction body.

In a further embodiment, the sensor device may comprise an optical sensor, preferably a camera or infrared sensor, wherein the optical sensor is configured to detect at least one of the contamination of the circulating conveyor element, the contamination of the containers and the friction characteristic value of the circulating conveyor element (and is arranged, for example, above, inside or below the container conveyor). In this way, a sensor can advantageously be provided which can detect both the contamination(s) and the friction characteristic value.

In one embodiment, the processing device is configured to operate the cleaning device depending on the signal output of the sensor device with regard to the detected contamination (e.g., of the circulating conveyor element and/or the containers) and/or the detected friction characteristic value to clean the circulating conveyor element when the circulating conveyor element is idle. Alternatively or additionally, the processing device can be configured to operate the cleaning device for cleaning the circulating conveyor element in such a way that the circulating conveyor element is successively cleaned only in portions of the circulating conveyor element that are free of containers. This can advantageously prevent the cleaning liquid intended for cleaning the conveyor element from undesirably reaching the containers.

In a further embodiment, the apparatus further comprises a device for processing and/or conveying containers, which is arranged upstream (of the containers) of the container conveyor.

In one exemplary embodiment, the processing device is further configured to operate the cleaning device depending on the signal output of the sensor device with respect to the detected contamination (e.g., of the circulating conveyor element and/or the containers) and/or the detected friction characteristic value to clean the circulating conveyor element when the device reports a fault and/or is stopped. This makes it advantageous to use downtimes or, for example, maintenance-related stoppages of the equipment, which result in containers temporarily not reaching the container conveyor, to clean the container conveyor using the cleaning device.

In a further embodiment, the processing device is further configured to operate the device (e.g., temporarily) to stop or slow down when the cleaning device is operated depending on the signal output of the sensor device regarding the detected contamination (e.g., of the circulating conveyor element and/or the containers) and/or the detected friction characteristic value to clean the circulating conveyor element. Advantageously, this allows temporary cleaning of the container conveyor by the cleaning device even during production operation.

In one embodiment, the cleaning device is configured to rinse the circulating conveyor element successively, preferably with water, then to process it with cleaning foam and then to rinse it again, preferably with water. This advantageously enables particularly thorough cleaning and, in particular, the removal of sticky lubricant residues.

In another embodiment, the cleaning device has at least one spray nozzle. Preferably, at least one spray nozzle can be arranged between an upper strand of the circulating conveyor element and a lower strand of the circulating conveyor element. Alternatively or additionally, at least one spray nozzle can be directed onto an upper side (container conveying side) of the circulating conveyor element and arranged, for example, below a lower strand of the circulating conveyor element or above an upper strand of the circulating conveyor element. Preferably, at least one spray nozzle can be directed only towards a lower strand of the circulating conveyor element, and/or at least one spray nozzle can have a plurality of outlet openings, of which at least one is directed towards an upper strand of the circulating conveyor element and at least one towards a lower strand of the circulating conveyor element, and/or a plurality of spray nozzles can be combined to form a spray bar. This advantageously enables thorough cleaning of the conveyor element from inside and/or outside the container conveyor.

In one embodiment, the cleaning device has a plurality of cleaning portions, which can be selectively connected, preferably by a valve system of the cleaning device, for selectively cleaning different (e.g., longitudinal) portions of the circulating conveyor element. Preferably, the processing device can be configured to determine a position of the contamination of the circulating conveyor element depending on a signal output of the sensor device; and to operate the cleaning device for cleaning the circulating conveyor element such that at least one cleaning portion of the plurality of selectively connectable cleaning portions is connected depending on the determined position for cleaning the detected contamination. Alternatively or additionally, the processing device can, for example, be configured to operate the cleaning device for cleaning the circulating conveyor element in such a way that the selectively connectable cleaning portions are selectively connected in such a way that the circulating conveyor element is only cleaned in portions of the circulating conveyor element that are free of containers. This advantageously allows the conveyor element to be cleaned only in portions, which, for example, increases flexibility during cleaning and saves cleaning liquid and cleaning time.

In a further embodiment, the apparatus further comprises a lubricating device, preferably with at least one lubricant spray nozzle and/or lubricant spray bar and/or lubricant brushes, for (e.g., metered) lubrication of a container contact side (e.g., top surface) of the circulating conveyor element. Preferably, the processing device can further be configured to operate the lubricating device for metered dispensing of a lubricant depending on a signal output of the sensor device with respect to the detected friction characteristic value, e.g., if the detected friction characteristic value is greater than a predefined target friction characteristic value and/or, for example, is outside a tolerance. Advantageously, the operation of the container conveyor can thus be kept within an optimal range by both the lubricating device and the cleaning device. The lubricating device and the cleaning device can preferably interact synergistically, since, for example, the cleaning device can be used when the lubricating device no longer produces the desired friction properties of the conveyor element despite lubricating the conveyor element. The cleaning device can then, for example, ensure that the conveyor element is returned to a basic state (e.g., unlubricated), from which optimization of the friction properties by the lubricating device becomes possible again.

In one exemplary embodiment, the user interface is configured to receive a user input of at least one operating parameter for the lubricating device, wherein the at least one operating parameter comprises:
a target friction characteristic value and optionally a permissible tolerance (hysteresis) around the target friction characteristic value; and/or
a pause time for successive valve openings when metering a lubricant by the lubricating device; and/or
a minimum valve opening time when metering a lubricant by the lubricating device; and/or
waiting time until the next detection of the friction characteristic value after lubrication using the lubricating device.

This advantageously enables lubrication of the conveyor element to be optimized for the corresponding application.

In a further exemplary embodiment, the processing device is further configured to record detected friction characteristic values and (performed) operations of the lubricating device. Optionally, the processing device may further be configured to operate the user interface for outputting, preferably graphically, the recorded friction characteristic values and operations of the lubricating device, and/or to send the recorded friction characteristic values and operations of the lubricating device to a plant controller and/or a remote server device (e.g., Internet server device). This can advantageously enable a subsequent evaluation of the lubrication in order to identify further potential for improvement.

In one embodiment, the processing device is further configured to operate the user interface to output the request to clean the circulating conveyor element and/or to operate the cleaning device to clean the circulating conveyor element if a signal output of the sensor device, after repeated operation of the lubricating device, indicates that the detected friction characteristic value of the circulating conveyor element is substantially unchanged or has increased. This also makes it possible to advantageously identify situations in which the friction characteristic value of the conveyor element cannot be improved by lubrication through the lubricating device due to, for example, external influences. This can be the case if, for example, clumped lubricant residues settle on the conveyor element due to excessive lubrication of the conveyor element.

A further aspect relates to a container processing facility (e.g., for controlling the temperature of, producing, cleaning, coating, testing, filling, closing, pasteurizing, labeling, printing, marking, laser marking, and/or packaging containers for liquid or pasty media, preferably beverages, liquid foods, or products from the pharmaceutical or healthcare industry). The container processing plant can comprise the apparatus as disclosed herein. The container processing plant can, for example, be a beverage filling plant. Advantageously, the container processing plant can achieve the same advantages as already described with reference to the apparatus.

For example, the containers can be realized as bottles, cans, canisters, cartons, vials, tubes, etc.

Preferably, the term “processing device” can refer to an electronic system (for example, embodied as a driver circuit or with microprocessor(s) and data memory) which, depending on the configuration, can perform control tasks and/or regulation tasks and/or processing tasks. Although the term “control” is used herein, this can also comprise or be understood as “closed-loop control” or “control with feedback” and/or “processing” as appropriate. The processing device can, for example, be a central processing device or have a plurality of decentralized or distributed processing units.

A further aspect relates to a method for operating an apparatus, preferably as disclosed herein, with a container conveyor having a circulating conveyor element (e.g., a conveyor belt, a mat chain, a hinged belt, a conveyor chain or a plate conveyor) for conveying containers (e.g., in a container processing plant). The method comprises the following:
detecting at least one of a contamination of the circulating conveyor element, a contamination of the containers and a friction characteristic value (e.g., friction coefficient, static friction coefficient and/or sliding friction coefficient) of the circulating conveyor element (e.g., relative to a reference body/friction body or to the containers) by a sensor device of the apparatus.

The method further comprises at least one of:
outputting a request to clean the circulating conveyor element by a user interface of the apparatus in dependence on the detecting; and
(e.g., automatic) cleaning of the circulating conveyor element by a(n) (e.g., stationary) cleaning device of the apparatus depending on the detection, preferably successively only in portions of the conveyor element free of containers and/or when the circulating conveyor element is idle.

Advantageously, the method can achieve the same advantages as already described herein with reference to the apparatus. The same applies to the preferred exemplary embodiments of the method explained in the following.

In one exemplary embodiment, the method further comprises at least one of the following:
(e.g., automatic) stopping or slowing down of a device for processing and/or conveying containers, which is arranged upstream (of the containers) of the container conveyor, when the circulating conveyor element is cleaned by the cleaning device;
(e.g., automatic) starting of the cleaning when a device for processing and/or conveying containers, which is arranged upstream (of the containers) of the container conveyor, reports a fault and/or is stopped;
(e.g., automatic and/or metered) lubrication of a container contact side of the circulating conveyor element by a lubricating device of the apparatus depending on the detection of the friction characteristic value;
specifying at least one operating parameter for the lubricating device by user input at the user interface, wherein the at least one operating parameter comprises: a target friction characteristic value and optionally a permissible tolerance (hysteresis) around the target friction characteristic value; and/or a pause time for successive valve openings when metering a lubricant using the lubricating device; and/or a minimum valve opening time when metering a lubricant using the lubricating device; and/or a waiting time until the next detection of the friction characteristic value after lubrication using the lubricating device;
recording the detected friction characteristic values and (performed) operations of the lubricating device;
outputting, preferably graphically outputting, the recorded friction characteristic values and operations of the lubricating device by the user interface;
sending the recorded friction characteristic values and operations of the lubricating device to a plant controller and/or a remote server device (e.g., Internet server device).

In a further exemplary embodiment, at least one of the following conditions is met:
the cleaning comprises successive rinsing, preferably with water, then foam cleaning and then rinsing, preferably with water, of the circulating conveyor element;
the cleaning comprises a successive, selective cleaning of different (e.g., longitudinal) portions of the circulating conveyor element by selectively connectable cleaning portions of the cleaning device;
the cleaning comprises cleaning a contamination of the circulating conveyor element, the position of which was previously detected by the sensor device, by a selectively connected cleaning portion of a plurality of selectively connectable cleaning portions of the cleaning device;
the cleaning comprises selectively connecting a plurality of selectively connectable cleaning portions of the cleaning device such that the circulating conveyor element is only cleaned in portions of the circulating conveyor element that are free of containers; and
the request to clean is output and/or the circulating conveyor element is cleaned if, after repeated (e.g., automatic) lubrication of a container contact side of the circulating conveyor element, the detected friction characteristic value of the circulating conveyor element is substantially unchanged or has increased (e.g., because a lubricant sticks to the circulating conveyor element).

The preferred embodiments and features of the invention described above can be combined with one another as desired.

### BRIEF DESCRIPTION OF THE FIGURE

Further details and advantages of the invention are described below with reference to the accompanying drawing, in which:

FIG. 1 shows an apparatus for conveying containers in accordance with an exemplary embodiment.

### DETAILED DESCRIPTION OF EMBODIMENTS

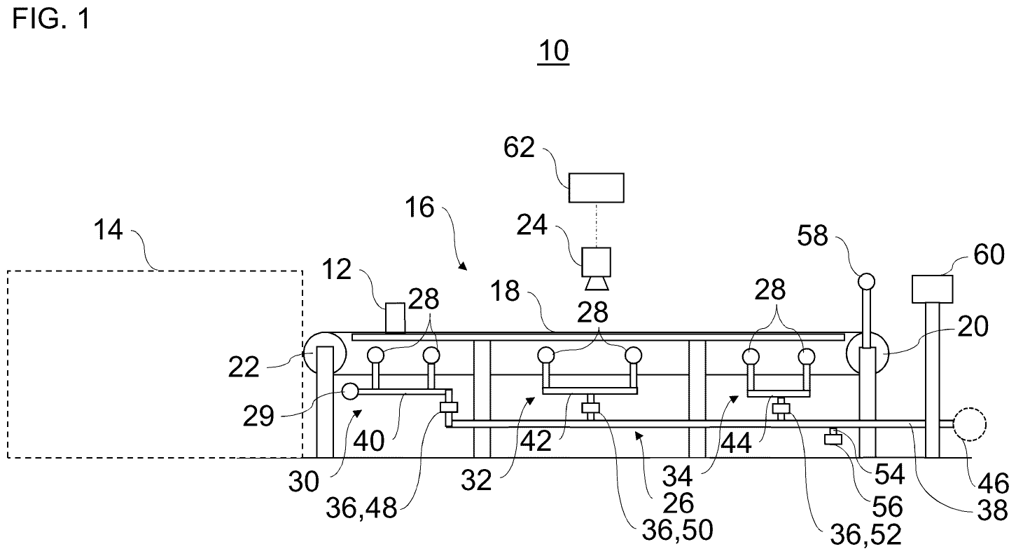

FIG. 1 shows an apparatus 10 for conveying containers 12. The apparatus 10 is preferably included in a container processing plant.

The apparatus 10 has a container conveyor 16 with a circulating conveyor element 18, a sensor device 24 and a processing device 62. In addition, the apparatus 10 has a user interface 60 and/or a cleaning device 26. Preferably, the apparatus 10 can also comprise a (further) device/machine 14 and/or a lubricating device 58.

The device/machine 14 is configured to process and/or convey the containers 12. For example, the device 14 can be configured to control the temperature of, manufacture, clean, coat, test, fill, close, pasteurize, label, print, mark, package, and/or transport the containers 12.

The device 14 can be arranged upstream of the container conveyor 16. For example, the device 14 may be located directly upstream of the container conveyor 16 or remotely upstream of the container conveyor 16.

It is possible that operation of the device 14 may be temporarily disrupted, e.g., due to a container 12 that has fallen over or become jammed, due to wear and tear, due to incorrect use or due to a lack of media supply (e.g., raw materials, auxiliary materials, operating materials, energy, etc.). Information about the occurrence of a fault in the device 14 can be received by the processing device 62, e.g., from a plant controller or the device 14 itself.

The container conveyor 16 has the circulating conveyor element 18 for conveying the containers 12. Preferably, the conveyor element 18 can support the containers 12 on the bottom side during conveying. The containers 12 can preferably stand upright on the conveyor element 18 during conveying.

The container conveyor 16 may, for example, comprise a rack with a frame and support legs for supporting the conveyor element 18.

The container conveyor 16 may have a guide device for laterally guiding the containers 12 transversely to the transport direction of the container conveyor 16. The guide device can preferably be arranged on one or both longitudinal sides of the container conveyor 16. The guide device may, for example, include guide railings or guide walls.

Preferably, the conveying element 18 can be liquid-permeable due to its construction. Liquid can pass from a bottom side of the conveyor element 18 to an upper side (container contact side) of the conveyor element 18 and vice versa. For example, the circulating conveyor element 18 can be a conveyor belt, a mat chain, a hinged belt, a conveyor chain or a plate conveyor.

The conveyor element 18 can, for example, revolve around a drive roller 20 and a deflection roller 22 of the container conveyor 16. The upper and lower strands of the conveyor element 18 can be supported, e.g., by support surfaces, rollers, etc. The drive roller 20 can be driven by a drive unit of the container conveyor 16 to move the circulating conveyor element 18 to convey the containers 12. The drive unit can, for example, be an electric motor.

The sensor device 24 is configured to detect contamination of the circulating conveyor element 18 and/or contamination of the containers 12 and/or a friction characteristic value of the circulating conveyor element 18. The sensor device 24 can have one or more sensors for this purpose.

It is possible that the sensor device 24 has a sensor that can detect both the contamination(s) and the friction characteristic value.

It is also possible for the sensor device 24 to have at least one sensor (contamination sensor) for detecting the contamination(s) and at least one further sensor (friction sensor) for detecting the friction characteristic value.

It is also possible that the sensor device 24 can have only one sensor (contamination sensor) for detecting the contamination(s) or only one sensor (friction sensor) for detecting the friction characteristic value.

The sensor device 24 can, for example, have at least one optical sensor and/or at least one contact sensor (touching sensor) for detecting the contamination(s) and/or the friction characteristic value.

For example, at least one optical sensor can be arranged above the container conveyor 16 and directed towards the circulating conveyor element 18. Alternatively or additionally, at least one optical sensor can be arranged in a protected manner within the container conveyor 16 or below the container conveyor 16 and directed towards the circulating conveyor element 18.

The at least one optical sensor can, for example, comprise a camera (e.g., with a CCD chip or CMOS chip), an infrared sensor, a laser sensor or an LED sensor. The detection of contamination(s) and/or the friction characteristic value can be carried out, for example, using image recognition algorithms.

By an image recognition algorithm, for example, contamination of the conveyor element 18 or a container 12 can be detected in a recording of the at least one optical sensor. Using an image recognition algorithm, for example, a movement of the containers 12 on the circulating conveyor element 18, e.g., when receiving or transferring the containers 12, can be analyzed and a friction characteristic value of the conveyor element 18 to the containers 12 can be determined.

Alternatively or in addition to the optical sensor, at least one contact sensor can be arranged on the upper strand of the conveyor element 18, on the lower strand of the conveyor element 18 and/or on the guide device of the container conveyor 16. For example, the conveyor element 18 can run along at least one contact sensor and/or the containers 12 can be moved along at least one contact sensor.

For example, the at least one contact sensor may comprise a biofilm sensor for detecting the contamination(s). The biofilm sensor can, for example, be arranged so that it temporarily or permanently touches a container contact side of the conveyor element 18 or the containers 12 are guided past the biofilm sensor.

It is also possible that the at least one contact sensor has a friction body and a force transducer connected thereto. The friction body can rest on the container contact side of the circulating conveyor element 18. Preferably, the friction body lies on the lower strand of the container contact side of the circulating conveyor element 18. Alternatively, the friction body can, for example, be located on the upper strand of the circulating conveyor element 18, but outside a transport path for the containers 12. For example, the friction body can be applied to the container contact side in such a way that the circulating conveyor element 18 slides along a surface of the friction body and a(n) (e.g., tensile) force acts on the friction body in the running direction of the conveyor element 18. This force can be measured using the force transducer and evaluated to determine the friction characteristic value. The detected friction characteristic value can, for example, have a friction number (friction coefficient), preferably a static friction coefficient and/or a sliding friction coefficient.

The cleaning device 26 is configured to clean the circulating conveyor element 18. For example, the cleaning device 26 can clean the circulating conveyor element 18 with water and/or foam. For example, the cleaning device 26 can rinse the circulating conveyor element 18 in a cleaning process one after the other, preferably with water, then process it with cleaning foam and then rinse it again, preferably with water.

Preferably, the cleaning device 26 can clean the circulating conveyor element 18 from within a frame of the container conveyor 16.

For example, the cleaning device 26 can have at least one spray nozzle 28 and/or 29.

Preferably, the at least one spray nozzle 28 can be arranged between an upper strand of the conveyor element 18 and a lower strand of the conveyor element 18.

At least one spray nozzle 28 can, for example, only be directed towards the lower strand. Alternatively or additionally, at least one spray nozzle 28 may have a plurality of outlet openings, of which at least one is directed towards the upper strand and at least one towards the lower strand of the conveyor element 18.

Preferably, the at least one spray nozzle 29 can be directed onto an upper side or container conveyor side/container support side of the conveyor element 18. The at least one spray nozzle 29 can, for example, be arranged below the lower strand of the conveyor element 18, as shown by way of example in FIG. 1. Alternatively, the at least one spray nozzle 29 can be arranged, for example, above the upper strand of the conveyor element 18 (not shown in FIG. 1).

It is possible that several spray nozzles 28 or several spray nozzles 29 are combined to form a spray bar (a spray beam/a spray lance). For example, a pipeline may have several spray nozzles spaced apart along a longitudinal axis of the pipeline/spray bar. The longitudinal axis of the pipeline/spray bar can, for example, be parallel or transverse to a longitudinal axis of the container conveyor 16. A spray bar consisting of several spray nozzles 28 can, for example, be arranged between the upper strand and the lower strand of the circulating conveyor element 18. A spray bar comprising several spray nozzles 29 can, for example, be arranged above the upper strand or below the lower strand of the conveyor element 18.

It is also possible to include several spray bars, each with several spray nozzles 28. The spray bars can, for example, be arranged parallel to each other.

Preferably, the cleaning device 26 has a plurality of selectively connectable cleaning portions 30, 32, 34. Depending on the connected cleaning portion 30, 32, 34, different portions of the circulating conveyor element 18 can be cleaned. Preferably, the cleaning portions 30, 32, 34 can be selectively connected to the cleaning device 26 using a valve system 36.

For example, the cleaning device 26 may have a main line 38 and several branch lines 40, 42, 44.

The main line 38 can be connected, for example, to a cleaning liquid source 46. The cleaning liquid source 46 can preferably provide at least one cleaning liquid, e.g., water and/or cleaning foam or, when sprayed, foam-forming cleaning liquid.

The branch lines 40, 42, 44 can preferably each have at least one spray nozzle 28 or at least one spray bar each with a plurality of spray nozzles 28.

The branch lines 40, 42, 44 can be arranged in mutually different regions of the container conveyor 16, e.g., in an upstream (container) end region of the container conveyor 16, in a middle region of the container conveyor 16, and/or in a downstream (of the containers) end region of the container conveyor 16. The branch lines 40, 42, 44 can thus define/specify the several cleaning portions 30, 32, 34.

The branch lines 40, 42, 44 can each branch off from the main line 38. Preferably, a valve 48, 50 or 52 of the valve system 36 can be arranged at the corresponding branch or in the corresponding branch line 40, 42, 44. The valves 48, 50, 52 are preferably embodied as shut-off valves. The branch lines 40, 42, 44 and thus the cleaning portions 30, 32, 34 can be selectively connected via the valves 48, 50, 52.

It is understood that the cleaning device 26-depending on the application-can have, for example, a different number of spray nozzles 28, a different number of cleaning portions 30, 32, 34, a different number of branch lines 40, 42, 44 and/or a different number of valves 48, 50, 52.

The selective connectability of the cleaning portions 30, 32, 34 enables, for example, a successive, selective cleaning of different portions of the circulating conveyor element 18 using the selectively connectable cleaning portions 30, 32, 34, e.g., controlled by the processing device 62. This can be beneficial in several scenarios.

For example, a limited cleaning liquid flow from the cleaning liquid source 46 can thus be distributed successively to the cleaning portions 30, 32, 34.

For example, the cleaning portions 30, 32, 34 can be selectively switched on and off during operation of the apparatus 10 such that the conveyor element 18 is only cleaned in portions of the conveyor element 18 that are free of containers 12.

For example, contamination of the conveying element 18 can be cleaned in a targeted manner. A position of the contamination can, for example, be previously detected by the sensor device 24. Depending on a signal output of the sensor device 24 regarding the detected position, the contamination can then be specifically cleaned using a selectively activated cleaning portion of the plurality of cleaning portions 30, 32, 34, e.g., controlled by the processing device 62.

It is possible that the cleaning device 26 for example also has a drain line 54. The drain line 54 can branch off from the main line 38. Preferably, a valve 56 may be arranged at the branch or in the drain line 54. The valve 56 is preferably embodied as a shut-off valve. Cleaning liquid can be drained from the main line 38 via the drain line 54 and the (open) valve 56.

The lubricating device 58 is configured to lubricate a container contact side of the conveyor element 18, e.g., with a dry, pasty, or liquid lubricant. For example, the lubricating device 58 may have at least one lubricant spray nozzle, lubricant spray bar and/or lubricant brush for lubricating the container contact side of the conveyor element 18.

The lubricating device 58 preferably dispenses the lubricant in a metered manner. For this purpose, for example, a supply valve of the lubricating device 58 can be opened and closed (=waiting time) in successive cycles for a predefined period of time (=valve opening time) until a predetermined amount of lubricant has been applied to the container contact side of the conveyor element 18.

Preferably, for example, the processing device 62 can record the detected friction characteristic values and operations (e.g., with regard to lubrication times and/or lubricant quantities) of the lubricating device 58. The recorded friction characteristic values and operations of the lubricating device 58 can then be output, for example, via the user interface 60. It is also possible to send the recorded friction characteristic values and operations of the lubricating device 58 to a plant controller of the container processing plant and/or a remote server device.

The user interface 60 may be configured to receive user inputs and/or to output information to a user. For example, the user interface 60 may be a visual, acoustic and/or haptic/tactile user interface. Preferably, the user interface 60 may comprise a, preferably touch-sensitive, display, a loudspeaker, a microphone, a keyboard, a button and/or at least one signal light.

The user interface 60 can be used by a user, for example, to enter operating parameters for the cleaning device 26 and/or the lubricating device 58.

Particularly preferably, the following operating parameters, individually or in any combination, can be predefined for the lubricating device 58 using the user interface 60:

a target friction characteristic value and a permissible tolerance (hysteresis) around the target friction characteristic value; a pause time for successive valve openings when metering a lubricant using the lubricating device 58; a minimum valve opening time when metering a lubricant using the lubricating device 58; a waiting time until the next detection of the friction characteristic value after lubrication using the lubricating device 58.

The apparatus 10 can further be operated as explained below, e.g., by the processing device 62.

Using the sensor device 24, contamination of the circulating conveyor element 18, contamination of the containers 12 and/or a friction characteristic value of the circulating conveyor element 18 can be detected. Depending on the configuration of the sensor device 24, it can detect only one, two or all three of the contamination of the circulating conveyor element 18, the contamination of the containers 12 and the friction characteristic value.

Depending on the detection, a request to clean the conveyor element 18 can then be output via the user interface 60. If, for example, contamination of the conveyor element 18 or contamination of the containers 12 is detected, the user interface 60 is operated accordingly to output the request. The user interface 60 can be operated alternatively or additionally to outputting the request depending on the detected friction characteristic value, e.g., if the detected friction characteristic value is substantially unchanged or has increased after repeated lubrication of the container contact side of the conveyor element 18, e.g., because a lubricant is sticking to the circulating conveyor element. For example, the processing device 62 may be configured to operate the user interface 60 as explained to output the request in dependence on a signal output of the sensor device 24.

However, it is particularly preferred that the circulating conveyor element is cleaned using the cleaning device 26 when contamination is detected or when the detected friction characteristic value is substantially unchanged or has increased after repeated lubrication of the container contact side of the conveyor element 18. For example, the processing device 62 may be configured to operate the cleaning device 26 as explained to clean the conveyor element 18.

Preferably, the cleaning device 26 can be operated during cleaning according to the at least one operating parameter predefined using the user interface 60, e.g., using the processing device 62.

Preferably, the container conveyor 16 can be cleaned when it is not transporting any containers 12, e.g., when the conveyor element 18 is idle. This can be, for example, during planned operational and maintenance breaks. However, it is also possible for cleaning to be carried out using the cleaning device 26 during temporary breaks in production operations.

For example, cleaning may start when the upstream device 14 reports a fault or is stopped, and thus no containers 12 are transported by the container conveyor 16. Preferably, the processing device 62 can be configured to operate the cleaning device 26 to clean the conveyor element 18 when the device 14 reports a fault and/or is stopped.

It is also possible for the device 14 to be stopped or slowed down separately when the circulating conveyor element 18 is cleaned using the cleaning device 26. For example, the processing device 62 may be configured to operate the device 14 to stop or slow down when the cleaning device 26 is operated to clean the conveyor element 18.

The invention is not limited to the preferred embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed independently of all of the features of independent claim 1 and, for example, independently of the features relating to the presence and/or configuration of the container conveyor, the circulating conveyor element, the sensor device, the user interface, the cleaning device and/or the processing device of independent claim 1. All ranges specified herein are to be understood as disclosed in such a way that all values falling within the relevant range are individually disclosed, e.g., also as the relevant preferred narrower outer limits of the relevant range.

### LIST OF REFERENCE SIGNS

10 apparatus
12 container
14 device for processing and/or conveying containers
16 container conveyor
18 circulating conveyor element
20 drive roller
22 deflection roller
24 sensor device
26 cleaning device
28 spray nozzle
29 spray nozzle
30 cleaning portion
32 cleaning portion
34 cleaning portion
36 valve system
38 main line
40 branch line
42 branch line
44 branch line
46 cleaning liquid source
48 valve
50 valve
52 valve
54 drain line
56 valve
58 lubricating device
60 user interface
62 processing device

1. An apparatus for conveying containers for a container processing plant, wherein the apparatus comprises:
a container conveyor with a circulating conveyor element for conveying the containers;
a sensor device which is configured to detect at least one of a contamination of the circulating conveyor element, a contamination of the containers and a friction characteristic value of the circulating conveyor element;
at least one of a user interface and a cleaning device for cleaning the circulating conveyor element; and
a processing device that is configured, depending on a signal output of the sensor device relating to at least one of the detected contamination and the detected friction characteristic value to at least one of:
operate the user interface to output a request to clean the circulating conveyor element; and
operate the cleaning device to clean the circulating conveyor element.

2. The apparatus according to claim 1, wherein:
the sensor device has at least one sensor for at least one of detecting the contamination of the circulating conveyor element and the contamination of the containers, and at least one further sensor for detecting the friction characteristic value, or
the sensor device has at least one sensor which is configured to detect at least one of the contamination of the circulating conveyor element, the contamination of the containers, and the friction characteristic value.

3. The apparatus according to claim 1, wherein the sensor device has at least one of the following:
a biofilm sensor for detecting at least one of the contamination of the circulating conveyor element and the contamination of the containers;
a friction body and a force transducer connected thereto for detecting the friction characteristic value, wherein the friction body rests on a container contact side of the circulating conveyor element, namely on a lower strand of the circulating conveyor element or on the upper strand of the circulating conveyor element outside a transport path for the containers; and
an optical sensor configured to detect at least one of the contamination of the circulating conveyor element, the contamination of the containers and the friction characteristic value of the circulating conveyor element.

4. The apparatus according to claim 1, wherein:
the processing device is further configured to at least one of:
operate the cleaning device depending on the signal output of the sensor device with regard to at least one of the detected contamination and the detected friction characteristic value to clean the circulating conveyor element when the circulating conveyor element is idle; and
to operate the cleaning device for cleaning the circulating conveyor element in such a way that the circulating conveyor element is successively cleaned only in portions of the circulating conveyor element that are free of containers.

5. The apparatus according to claim 1, further comprising:
a device for at least one of processing and conveying containers arranged upstream of the container conveyor,
wherein:
the processing device is further configured to at least one of:
operate the cleaning device depending on the signal output of the sensor device with regard to at least one of the detected contamination and the detected friction characteristic value to clean the circulating conveyor element when the device at least one of reports a fault and is stopped; and
operate the device for stopping or slowing down when the cleaning device is operated depending on the signal output of the sensor device with regard to at least one of the detected contamination and the detected friction characteristic value to clean the circulating conveyor element.

6. The apparatus according to claim 1, wherein:
the cleaning device is configured to rinse the circulating conveyor element successively, then to process the circulating conveyor element with cleaning foam, then to rinse the circulating conveyor element it again.

7. The apparatus according to claim 1, wherein at least one of:
the sensor device includes a camera or infrared sensor; and
the cleaning device is configured to rinse the circulating conveyor element with water.

8. The apparatus according to claim 1, wherein:
the cleaning device has one of at least one spray nozzle and a plurality of cleaning portions that are selectively connectable for selectively cleaning different portions of the circulating conveyor element.

9. The apparatus according to claim 8, wherein at least one of the following is met:
at least one spray nozzle is arranged between an upper strand of the circulating conveyor element and a lower strand of the circulating conveyor element;
at least one spray nozzle is directed onto an upper side of the circulating conveyor element;
at least one spray nozzle is directed only towards a lower strand of the circulating conveyor element;
at least one spray nozzle has a plurality of outlet openings, of which at least one is directed towards an upper strand of the circulating conveyor element and at least one is directed towards the lower strand of the circulating conveyor element; and
several spray nozzles are combined to form a spray bar.

10. The apparatus according to claim 8, wherein:
the plurality of cleaning portions are selectively connected using a valve system of the cleaning device; and
the processing device is further configured to at least one of:
determine a position of the contamination of the circulating conveyor element depending on a signal output of the sensor device; and to operate the cleaning device to clean the circulating conveyor element in such a way that at least one cleaning portion of the plurality of selectively connectable cleaning portions is connected depending on the determined position for cleaning the detected contamination; and
operate the cleaning device for cleaning the circulating conveyor element in such a way that the selectively connectable cleaning portions are selectively connected in such a way that the circulating conveyor element is only cleaned in portions of the circulating conveyor element that are free of containers.

11. The apparatus according to claim 1, further comprising:
a lubricating device for lubricating a container contact side of the circulating conveyor element,
wherein:
the processing device is further configured to operate the lubricating device for metered dispensing of a lubricant depending on a signal output of the sensor device with respect to the detected friction characteristic value.

12. The apparatus according to claim 11, wherein:
the user interface is configured to receive a user input of at least one operating parameter for the lubricating device, and the at least one operating parameter comprises at least one of:
a target friction characteristic value and a permissible tolerance around the target friction characteristic value;
a pause time for successive valve openings when metering a lubricant using the lubricating device;
a minimum valve opening time when metering a lubricant using the lubricating device; and
a waiting time until the next detection of the friction characteristic value after lubrication using the lubricating device.

13. The apparatus according to claim 11, wherein:
the processing device is further configured to:
record the detected friction characteristic values and operations of the lubricating device.

14. The apparatus according to claim 11, wherein at least one of:
the lubricating device includes at least one of a lubricant spray nozzle, a lubricant spray bar and lubricant brushes; and
the processing device is further configured to at least one of:
operate the user interface for graphically outputting the recorded friction characteristic values and operations of the lubricating device; and
send the recorded friction characteristic values and operations of the lubricating device to at least one of a plant controller and a remote server device.

15. The apparatus according to claim 11, wherein:
the processing device is further configured to:
operate the user interface at least one of to output the request to clean the circulating conveyor element and to operate the cleaning device to clean the circulating conveyor element if a signal output of the sensor device, after repeated operation of the lubricating device, indicates that the detected friction characteristic value of the circulating conveyor element is substantially unchanged or has increased.

16. A method for operating an apparatus with a container conveyor having a circulating conveyor element for conveying containers, wherein the method comprises:
detecting at least one of a contamination of the circulating conveyor element, a contamination of the containers and a friction characteristic value of the circulating conveyor element using a sensor device of the apparatus;
wherein the method further has at least one of the following:
outputting a request to clean the circulating conveyor element using a user interface of the apparatus in dependence on the detecting; and
cleaning the circulating conveyor element using a cleaning device of the apparatus depending on the detecting.

17. The method according to claim 16, further comprising at least one of the following:
stopping or slowing down a device for at least one of processing and conveying containers, which is arranged upstream of the container conveyor when the circulating conveyor element is cleaned using the cleaning device;
starting the cleaning when a device for at least one of processing and conveying containers, which is arranged upstream of the container conveyor, at least one of reports a fault and is stopped; and
lubricating a container contact side of the circulating conveyor element using a lubricating device of the apparatus in dependence on the detecting of the friction characteristic value.

18. The method according to claim 17, wherein the method further comprises at least one of:
specifying at least one operating parameter for the lubricating device using user input at the user interface, wherein the at least one operating parameter comprises at least one of:
a target friction characteristic value and a permissible tolerance around the target friction characteristic value;
a pause time for successive valve openings when metering a lubricant using the lubricating device;
a minimum valve opening time when metering a lubricant using the lubricating device; and
a waiting time until the next detection of the friction characteristic value after lubrication using the lubricating device;
recording the detected friction characteristic values and operations of the lubricating device;
outputting the recorded friction characteristic values and operations of the lubricating device using the user interface; and
sending the recorded friction characteristic values and operations of the lubricating device to at least one of a plant controller and a remote server device.

19. The method according to claim 16, wherein at least one of the following is met:
the cleaning comprises a successive rinsing then foam cleaning and then rinsing of the circulating conveyor element;
the cleaning comprises a successive, selective cleaning of different portions of the circulating conveyor element using selectively connectable cleaning portions of the cleaning device;
the cleaning comprises cleaning a contamination of the circulating conveyor element, the position of which was previously detected by the sensor device, using a selectively connected cleaning portion of a plurality of selectively connectable cleaning portions of the cleaning device;
the cleaning comprises selectively connecting a plurality of selectively connectable cleaning portions of the cleaning device such that the circulating conveyor element is only cleaned in portions of the circulating conveyor element that are free of containers; and
at least one of the request to clean is output and the circulating conveyor element is cleaned when, after repeated lubrication of a container contact side of the circulating conveyor element, the detected friction characteristic value of the circulating conveyor element is substantially unchanged or has increased.

20. The method according to claim 16, wherein at least one of:
the cleaning the circulating conveyor element using the cleaning device is at least one of successively only in portions of the conveyor element free of containers and when the circulating conveyor element is idle;
the cleaning includes a successive rinsing with water, then a foam cleaning and then rinsing with water of the circulating conveyor element; and
the apparatus includes:
the container conveyor with the circulating conveyor element for conveying the containers,
the sensor device configured to detect at least one of a contamination of the circulating conveyor element, a contamination of the containers and a friction characteristic value of the circulating conveyor element,
at least one of a user interface and the cleaning device for cleaning the circulating conveyor element; and
a processing device that is configured, depending on a signal output of the sensor device relating to at least one of the detected contamination and the detected friction characteristic value to at least one of:
operate the user interface to output a request to clean the circulating conveyor element; and
operate the cleaning device to clean the circulating conveyor element.
